(19) United States
(12) Patent Application Publication
(10) Pub. No.: US 2023/0419440 A1
(43) Pub. Date: Dec. 28, 2023

(54) METHOD FOR PROVIDING IMAGE RECORDINGS IN A VEHICLE

(71) Applicant: Robert Bosch GmbH, Stuttgart (DE)

(72) Inventors: Claus Spizig, Stuttgart (DE); Andreas Feder, Leonberg (DE); Bane Strahinjic, Leonberg (DE)

(21) Appl. No.: 18/331,722

(22) Filed: Jun. 8, 2023

(30) Foreign Application Priority Data
Jun. 24, 2022 (DE) 102022206379.1

(51) Int. Cl. G06T 3/40; G06V 20/56; G06T 5/50

(52) U.S. Cl. CPC G06T 3/40; G06V 20/56; G06T 5/50

(57) ABSTRACT

A method for providing image recordings in a vehicle. The method includes the following steps performed in automated manner: acquiring a first image recording of a first image sensor of the vehicle and at least one further image recording of at least one further image sensor of the vehicle, the image recordings imaging different spatial regions of the surroundings of the vehicle, whereby at least one item of information of relevance to a function of the vehicle is provided and the image recordings differing with regard to their resolution and/or their image format; performing an adjustment of the image recordings with regard to their resolution and/or their image format to a preset, the preset being dependent on at least one instance of processing performed on execution of the vehicle function; providing the adjusted image recordings for processing.

### CROSS REFERENCE

The present application claims the benefit under 35 U.S.C. § 119 of German Patent Application No. DE 10 2022 206 379.1 filed on Jun. 24, 2022, which is expressly incorporated herein by reference in its entirety.

### FIELD

The present invention relates to a method for providing image recordings in a vehicle. The present invention furthermore relates to a computer program and to a device for this purpose.

### BACKGROUND INFORMATION

Conventionally, vehicle functions such as driver assistance systems, parking aids or highly automated driving perform processing of sensor data which are captured by at least one sensor such as a camera sensor of a vehicle. Accurate knowledge of sensor characteristics is conventionally necessary here. Sensor characteristics include, for example, a resolution or image format of the sensor. When it comes to developing or adapting a processing unit which is intended to provide a vehicle function, account must be taken of the sensor characteristics of the sensor which is used. This creates a dependency on the specific type of sensor used and the development of the sensor and the processing unit also becomes closely interlinked. As a result, technical coordination becomes more complex and development flexibility is reduced.

### SUMMARY

The present invention provides a method, a computer program, and a device for providing image recordings in a vehicle. Further features and details of the present invention are revealed by the description and the figures. Features and details which are described in connection with the method according to the present invention naturally also apply in connection with the computer program according to the present invention and the device according to the present invention and vice versa in each case, such that reference is or can be made mutually with regard to the disclosure of the individual aspects of the present invention.

A method according to the present invention in particular serves to provide image recordings in a vehicle. The vehicle is for example a motor vehicle and/or a self-driving vehicle and/or a truck and/or a passenger car. The image recordings are in particular data which represent at least one image or a sequence of images.

According to an example embodiment of the present invention, provision may be made for the following steps to be performed in automated manner, preferably in the stated sequence and/or repeatedly:
acquiring a first image recording of a first vehicle image sensor and at least one further image recording of at least one further (e.g. second, third, fourth etc.) vehicle image sensor, for example by receiving the image recordings from the image sensors, the image recordings preferably imaging different spatial regions of the surroundings of the vehicle, whereby at least one item of information of relevance to a function of the vehicle is provided and the image recordings preferably differing with regard to their resolution and/or their image format,
performing an adjustment of the image recordings, preferably with regard to their resolution and/or their image format, to a preset, the preset being dependent on at least one instance of processing performed during execution of the vehicle function, in particular being predetermined by the processing,
providing the adjusted image recordings for processing, preferably in order in this way to execute the vehicle function on the basis of the relevant information, in particular by initiating processing with the adjusted image recordings as the input for processing.

The method according to the present invention has thus the advantage that the image recordings can be successfully processed even with sensors from different manufacturers and/or image recordings of a different resolution and/or image format. The image sensors may differ according to their key parameters such as their structure and/or sensor characteristics. It is furthermore possible for adjustment to proceed in the course of data compression of the image recordings, such that synergistic effects between data compression and adjustment can be exploited here. This is for example possible because data compression removes part of the image recordings and adds a replacement fraction to the image recordings, in particular in the form of pseudo-noise. Accordingly, when this addition is made, it is optionally also possible to embed additional information such as a reference marker into the image recordings which is used for later adjustment.

Adjustment comprises, for example, converting image recordings of a different image format and/or different resolution into another image format and/or another resolution. The other image format and/or the other resolution may here be predetermined by the preset. The preset is for example dependent on the processing in that the processing requires and/or defines the specified image format and/or the predetermined resolution. It is often the case that a vehicle function requires a certain image format and/or a certain resolution of the image recordings as input. This may thus be taken to be the preset. The preset may also be understood to be a stored specification as to how the image recordings are to be adjusted (e.g. the desired image format). Adjustment of the image recordings to the preset may thus comprise standardization of the image format and/or of at least one further parameter of the image recordings.

According to an example embodiment of the present invention, during acquisition of the image recordings, the further image recordings, thus for example at least one second image recording, third image recording etc., can also be acquired in addition to the first image recording. The image recordings may have been captured timewise in parallel by the different image sensors. The image sensors may furthermore be arranged at different positions on the vehicle. Accordingly, different spatial regions of the vehicle's surroundings can be imaged by the image recordings, said regions possibly partially overlapping and/or including redundant information. For example, a first image sensor may be oriented in the direction of travel (front), and/or a second image sensor oriented in a direction opposite to the direction of travel, and/or a third image sensor oriented toward a left-hand blind spot and/or a fourth image sensor oriented toward a right-hand blind spot.

The at least one item of relevant information may comprise for example at least one of the following items of information:
an item of speed information about the vehicle's speed,
an item of object information about at least one object in the vehicle's surroundings, for example at least one vehicle in front,
an item of distance information about a distance from a vehicle in front.

According to an example embodiment of the present invention, the at least one vehicle function comprises for example a driver assistance system and/or a parking aid and/or highly automated driving. The image sensor may be a camera and in particular a stereo camera. Another device for capturing the surroundings such as a radar sensor or the like may also be understood to be an image sensor. The image recordings may accordingly in each case take the form of at least two-dimensional or three-dimensional image data.

Performance of the adjustment may include adjustment and optionally also stitching together of those image recordings which have been recorded timewise in parallel, and thus at substantially the same point in time. The image recordings advantageously image at least partially differing regions of the vehicle's surroundings which contain the relevant information and can therefore be assembled like a jigsaw puzzle.

It is furthermore optionally provided that adjustment be performed during data compression and/or data decompression of the image recordings. Adjustment may for example proceed immediately together with compression or decompression. It is possible for transmission of the image recordings to take place within the vehicle prior to adjustment. In order to reduce the volume of data to be transmitted, compression may be performed before transmission and decompression after transmission. For example, a central control device may receive the image recordings from different vehicle image sensors, which recordings, once acquired by the image sensors, are in each case accordingly transmitted to the control device. The transmitted image recordings can then be adjusted, optionally centrally.

A further advantage may be achieved for the purposes of the present invention if the adjustment comprises standardization of the resolutions of the image recordings to a (uniform) target resolution and/or of the image formats of the image recordings to a (uniform) target image format such that the image recordings are available in the target resolution and/or target image format during processing. It is thus also possible to standardize the image formats to a sensor-independent format into which the data, i.e., the image recordings, are converted. The same applies to the resolution, which can likewise be standardized.

It may furthermore be provided for the purposes of the present invention that processing be configured to receive and/or process the image recordings solely in a uniform resolution calculated by the adjustment and/or a uniform image format calculated by the adjustment, in particular a target resolution and/or a target image format. Subsequent processing may thus be independent of the specific image format and/or specific resolution at which an image sensor provides an image recording for processing. The adjustment may thus also be understood as an adapter between the various image sensors and processing.

It may further be advantageously provided that at least one additional item of information be integrated into the image recordings. The additional item of information may be specific to the resolution and/or the image format, i.e. contain an indication of the specific resolution and/or image format used during image recording. The adjustment can be performed on the basis of the additional item of information, for example by evaluating and taking account of the indication regarding resolution or image format. At least one reference marker, in particular at least one reference bit, can also be used as the additional information. At least one item of metadata information, for example about the image sensor and/or image format and/or resolution, can be embedded into the image recordings by the additional information. It is possible for the metadata information also to be used for processing steps other than adjustment, for example by processing and/or by data compression and/or decompression. It is furthermore possible for the at least one reference marker to indicate a position of the image sensor on the vehicle. The additional information can, for example, be inserted directly into the image content of the image recordings and/or into an additional data area. The image recordings may accordingly also be understood as data containers which comprise the image content and the additional data area.

According to an example embodiment of the present invention, it may furthermore be possible for acquisition of the image recordings to be performed decentrally in the vehicle at the respective image sensor, the image recordings then being transmitted to an in particular electronic processing unit, preferably a central control device, adjustment then being performed, in particular by the processing unit, after transmission. This has the advantage that adjustment can be performed centrally. Decentralized acquisition of the image recordings may additionally proceed independently of knowledge as to which image format and/or which resolution is/are required for subsequent processing.

According to an example embodiment of the present invention, one further possibility may provide that, after acquisition and before adjustment, data compression and transmission of the image recordings are performed, transmission from the image sensors preferably being performed from different positions on the vehicle and with different transmission paths. Data compression can thus bring about a distinct reduction in the volume of data transmitted within the vehicle.

It is further possible for the image recordings to be stitched together as a function of the imaged surrounding regions, whereby a stitched-together image recording is obtained, the stitched-together image recording being adjusted and/or provided for processing. The method can therefore make it possible to compose an overall view around the vehicle from a plurality of image sensors from different manufacturers and of different types and resolutions, such that it can be further processed by an algorithm during processing. Processing need not here take account of the different manufacturers, types and resolutions since the image recordings can be uniformly adjusted beforehand.

A further advantage for the purposes of the present invention is achievable if the adjustment is performed by a trained algorithm which was obtained by training with image recordings of a different resolution and/or different data format. For example, provision may be made to use data from different data sources for training the algorithms of the processing unit, even if the resolution is initially not uniform and/or is unknown to the algorithm. It is thus possible to use a trained algorithm, in particular an artificial neural network, for the adjustment.

According to an example embodiment of the present invention, it may advantageously be provided for the purposes of the present invention for lossy data compression of the image recordings to be performed, the lossy data compression comprising the following steps:
performing preparation of the respective image recording, in which part of the image recording, in particular also referred to as the first data fraction, is removed and an artificially generated and reproducible replacement fraction is defined by an item of replacement information as an approximation of the removed part in order to prepare the image recording for lossless data compression,
performing lossless data compression on the respectively prepared image recording.

The replacement information can here be transmitted instead of the removed part during a respective transmission of the image recordings. It is thus possible to significantly reduce the volume of data to be transmitted. Performance of the preparation may furthermore comprise at least the following step:
introducing at least one item of additional information into the image recording, which information preferably comprises an item of metadata information and/or a reference marker, on the basis of which the adjustment is performed.

It is thus possible to combine adjustment with data compression. Furthermore, at least one additional item of information such as at least one reference marker may already be embedded in the image recordings during data compression. Using the reference marker, it is possible, for example, to determine the position of the image sensors relative to one another and/or to identify a resolution of the image recordings. The at least one reference marker may here be specific to the position and/or orientation and/or a resolution of the image sensors.

Furthermore, the additional information, and in particular the reference marker, can specify a scale of the image recordings. As an indication of scale, the reference marker can thus also serve to acquire and/or check resolution during adjustment. The additional information can furthermore indicate the resolution and/or the image format for example also directly, preferably in value terms.

Furthermore, a fraction of the image recordings, which optionally represents a fraction of each pixel, can in each case be understood as the removed part and the replacement fraction. The fraction is, for example, a noise fraction. Synergies may in particular be achieved here by combining performing adjustment according to the present invention with efficient data compression. For example, both the removal of the first data fraction and the adjustment and/or introduction of the additional information can accordingly be performed in the zone control device.

The described data compression furthermore gives rise to the advantage that more data and more relevant data can be transmitted, even if the data link used for this purpose is only a relatively low bandwidth link. The data can here be compressed to a significantly greater degree than is possible in many conventional methods. At the same time, corruption of the data can be avoided since the first data fraction is not merely removed but a replacement fraction is additionally provided as an approximation of the removed part.

The replacement fraction may be artificially generated and/or reproducible. This means that the replacement fraction is not obtained from a modification or change to the removed part but can instead be completely artificially generated even without knowledge of the removed part using the replacement information. To this end, a generator such as a random number generator is used, for example, which can generate the replacement fraction for example as a matrix or vector of random numbers on the basis of the replacement information, such as a seed for example. This has the advantage that the replacement fraction itself does not have to be transmitted, only the replacement information. The replacement information may here merely be a key such as a seed key and thus have a much smaller data size of a few bits in comparison with the replacement fraction and the removed part. For example, the replacement information has at most 1% of the data size of the replacement fraction and/or the removed part.

The image recordings can be transmitted as data within the vehicle. Data compression has the advantage that the volume of data to be transmitted can be reduced. The image recordings are therefore also referred to below simply as data in the more detailed description of data compression.

It is possible for the replacement information to be restored during decompression and imprinted on the respective transmitted image recordings. This imprinting can optionally be combined with the adjustment of the image recordings in order to exploit synergistic effects and reduce computational effort.

It is possible for the purposes of the present invention for the removed part, in particular also referred to as the first data fraction, to be a noise fraction of the data and/or the replacement fraction to be artificially generated noise, in particular pseudo-noise. The removed part may be a specific fraction of the data which can be characterized and selected according to predetermined and in particular statistical criteria. When the first data fraction is removed, the prepared data may only still comprise the fraction of data remaining after removal. (For the purposes of the present invention, the removed part is also referred to as the first data fraction and the remaining fraction as the second data fraction). The remaining fraction may have the relevant information content, for example a recording of a vehicle's surroundings. In contrast, the removed part may have a smaller and predominantly random information content, for example as noise representing merely statistically distributed energy.

It may be provided for the purposes of the present invention that the data compressed by way of lossless data compression and/or the replacement fraction be restored bit-identically on the basis of the replacement information after transmission. However, in combination with preparation, lossy data compression of the data can still result, since the first data fraction is removed and the lossless data compression is applied only to the remaining fraction of the data. “Bit-identical” is in particular taken to mean that each bit of the data is identical and can thus be restored losslessly.

It is possible that, by removing the first data fraction, in particular noise fraction, of the data, it is possible to achieve far higher compression than would be the case with conventional methods. Since the removed first data fraction may have a somewhat random and statistically distributed information content, only inefficient compression would be possible. Due to the predominantly random content of the removed part, it can be statistically approximated instead and so enable substitution by the artificially generated replacement fraction. In contrast, the data fraction remaining after removal cannot be statistically replicated due to its predominantly non-random information content but can nevertheless be better compressed due to the extensive redundant information. In other words, the acquired data can consist of a random first data fraction, in particular noise, and a second data fraction with a large fraction of redundant information. If the data take the form of image data, the first data fraction may be the (superimposed) noise fraction of the image, and the second data fraction the remaining fraction of the image after subtracting the noise. This may also apply to each pixel of the image, which may consist of the first (random, noise) and second (redundant) data fraction. The, in particular lossless, data compression can be applied to the second (redundant) data fraction. The first data fraction may, in contrast, be replaced by the replacement fraction, in particular on the basis of a noise model. Since the replacement fraction does not have to be transmitted but can be reproduced bit-identically using the replacement information, the data size to be transmitted is reduced. While the replacement fraction corresponds (only) approximately to the first data fraction, the original data fraction is irretrievably lost, such that this procedure can also be understood as lossy data compression. In other words, this lossy data compression for the first data fraction is combined with the lossless data compression for the second data fraction. A condensed data volume can thus be transmitted.

Since the first data fraction is removed and moreover is not reproducible, the method according to an example embodiment of the present invention may comprise lossy data compression in which, while the first data fraction is lost, the remaining second data fraction is optionally losslessly compressed. In order to avoid corruption of the data, a replacement fraction can be generated instead of the first data fraction. After transmission, the replacement fraction can be losslessly, in particular bit-identically, reproduced and reimprinted on the transmitted data. Reproducible pseudo-noise may, for example, be used as the replacement fraction. While the replacement fraction does not bit-identically replace the removed part, it comes very close to doing so. A strong compression factor can be achieved by imprinting reproducible pseudo-noise in this way. The remaining fraction of the data and the replacement fraction can be bit-identically restored after transmission. If the removed first data fraction is a noise fraction of the data, replacement of the noise fraction by the replacement fraction may also be referred to as noise substitution. Noise substitution allows the majority of the random noise in the data, which can be characterized by an input noise model, to be replaced by the pseudo-noise, which is characterized by a target noise model.

It is additionally possible for the purposes of the present invention for the replacement fraction to be defined in that the replacement information, in particular a seed key for a generator such as a random number generator, is determined, the replacement fraction then preferably being reproduced by way of the replacement information, in particular after data transmission. The replacement information thus uniquely defines the replacement fraction, i.e., for example the pseudo-noise, such that the replacement fraction can be reproduced bit-identically on the basis of the replacement information. To this end, the replacement information is used for example by a generator or random number generator to generate the replacement fraction in the form of a two-dimensional matrix. The seed key may for example be acquired by measuring the noise characteristic of the (real) image sensor. The statistics of this pseudo-noise consequently optionally correspond to the noise actually occurring in the image sensor, but are however bit-identically reproducible.

The present invention likewise provides a computer program, in particular a computer program product, comprising commands which, on execution of the computer program by a computer, cause the latter to execute the method according to the present invention. The computer program according to the present invention is thus associated with the same advantages as have been described in detail with reference to a method according the present invention.

The present invention likewise provides a device for data processing. The data processing device according to an example embodiment of the present invention may be embodied as the computer and/or as a system which comprises inter alia the processing unit. The device according to the present invention can moreover execute the computer program and/or the method. The computer may have at least one processor for executing the computer program. A nonvolatile data memory may also be provided, in which the computer program may be stored and from which the computer program may be read by the processor for execution. The device according to the present invention may also have a plurality of processors and/or be embodied as a computer system. For example, the device according to the present invention may comprise a central control device of the vehicle and/or one or more distributed zone control devices of the vehicle. The device according to the present invention may optionally also denote the entire vehicle electronics.

The present invention may likewise provide a computer-readable storage medium which comprises the computer program according to the present invention. The storage medium for example takes the form of a data memory such as a hard disk and/or a nonvolatile memory and/or a memory card. The storage medium may for example be integrated into the computer.

The method according to the present invention may furthermore also be embodied as a computer-implemented method.

Further advantages, features and details of the present invention are revealed by the following description, in which exemplary embodiments of the present invention are described in detail with reference to the figures. The features mentioned in the description may each be essential to the present invention individually or in any combination.

### BRIEF DESCRIPTION OF THE DRAWINGS

FIG. 1 is a visualization of the method steps of a method according to an example embodiment of the present invention.

FIG. 2 is a further visualization of the method steps of a method according to an example embodiment of the present invention.

FIG. 3 is a visualization of the method steps of a method according to an example embodiment of the present invention with further details.

In the figures, the same reference signs are used for the same technical features even of different exemplary embodiments.

### DETAILED DESCRIPTION OF EXAMPLE EMBODIMENTS

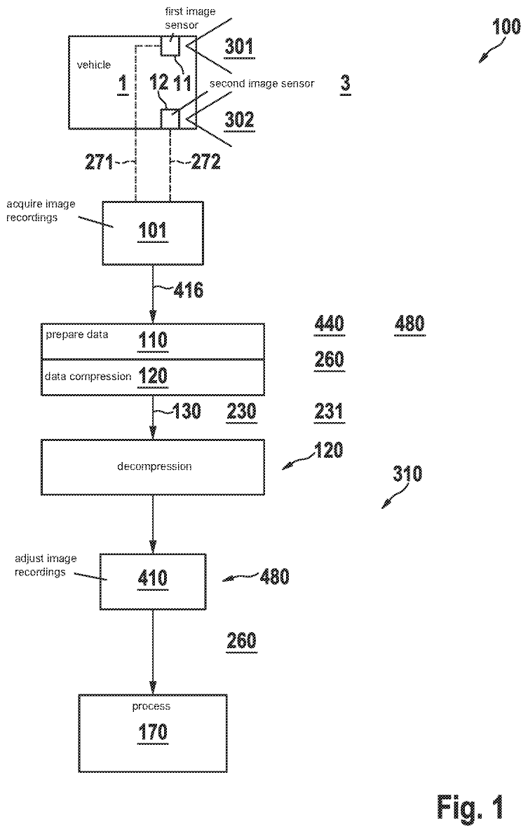

FIG. 1 visualizes a method according to the present invention 100 by way of example. In this method, the following steps can be performed in automated manner to provide image recordings 271, 272 in a vehicle 1. First of all, a first image recording 271 of a first image sensor 11 of the vehicle 1 and at least one further image recording 272 of at least one further image sensor 12 of the vehicle 1 may be acquired 101. The image recordings 271, 272 may here image different spatial regions 301, 302 of the surroundings 3 of the vehicle 1. In this manner, at least one item of information of relevance to a function of the vehicle 1 is provided. The image recordings 271, 272 may furthermore differ with regard to their resolution and/or their image format, in particular because the image sensors 11, 12 have a different structure and/or different specifications. Then, optionally after transmission 130 of the image recordings 271, 272, the image recordings 271, 272 may be adjusted 410. Specifically, the resolution may for example be increased or decreased or the current image format can be converted into another image format in order to carry out the adjustment. The image format may for example define the file format and/or the resolution and/or the aspect ratio and/or the scale in or at which the image recordings 271, 272 are present and/or image the surrounding regions 301, 302. Adjustment 410 of the image recordings 271, 272 can accordingly be performed with regard to their resolution and/or their image format. The adjustment 410 is made for example to a preset, the preset possibly being defined by at least one instance of processing 170 performed on execution of the vehicle function. In other words, adjustment 410 can proceed such that the image format and/or the resolution of the image recordings 271, 272 correspond to the preset after the adjustment 410. The preset may for example be stored in a nonvolatile data memory in the vehicle 1. The adjusted image recordings 271, 272 can then be provided for processing 170. For this purpose, the adjusted image recordings 271, 272 can, for example, be transmitted as data to an electronic processing unit 310.

It may further be provided that at least one additional item of information 260, which is specific to the resolution and/or the image format, be integrated into the image recordings 271, 272. An item of information about the resolution and/or the image format can thus be stored in the image recordings 271, 272, for example in the form of metadata information 440. This allows the adjustment 410 to be performed on the basis of the additional information 260, for example by the metadata information 440 being evaluated during the adjustment 410. For example, the additional information 260 can be used to check whether the resolution and/or the image format already correspond to a preset and/or to what extent they deviate from the preset. The additional information may also be integrated, for example, by a reference marker 480 inserted into the image recordings 271, 272. This allows specific regions of the images to be characterized, in order, for example, to determine a scale and/or a position of the images. Optionally, the image format can be at least partially acquired on the basis of the reference marker 480 during the adjustment 410.

Acquisition 101 of the image recordings 271, 272 can be performed decentrally in the vehicle 1 at the respective image sensors 11, 12 at different positions on the vehicle 1. The image recordings 271, 272 can then be transmitted to a processing unit 310, in particular to a central control device 310. After transmission 130, adjustment 410 can be performed, in particular by the processing unit 310. Furthermore, after acquisition 101 and before adjustment 410, it is possible to perform data compression 120 and transmission 130 of the image recordings 271, 272 from the image sensors 11, 12 and thus from the different positions on the vehicle 1, moreover using different transmission paths. A representative transmission path is here shown by an arrow 130. After transmission 130, decompression 120 may proceed. For simplicity, compression and decompression are denoted by the same reference sign in FIG. 1.

It is furthermore possible for the image recordings 271, 272 to be stitched together according to the imaged surrounding regions 301, 302, whereby a stitched-together image recording 416 is obtained, the stitched-together image recording 416 being adjusted and/or provided for processing 170.

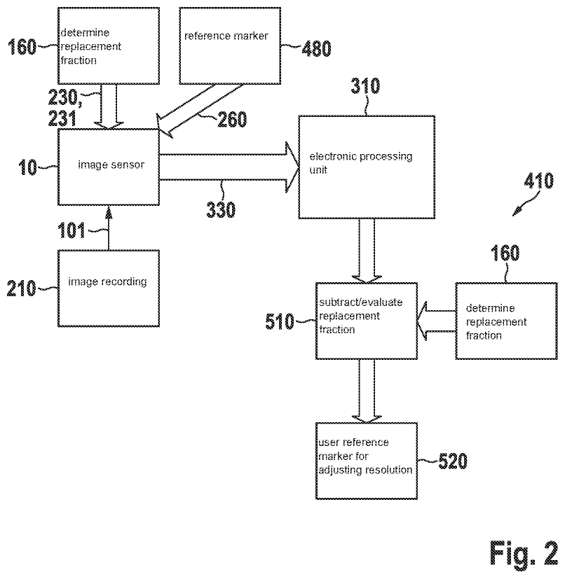

FIG. 2 shows the adjustment 410 with further details. As a prerequisite for the adjustment 410, it may be provided that additional information 260 is first acquired and/or added after the acquisition 101 of a respective image recording 210 by an image sensor 10. The additional information 260 may be set as a default and comprise a specification of the image sensor 10, such as a resolution and/or an image format. The additional information 260 may also comprise a reference marker 480. Addition may be performed efficiently in the course of data compression, in particular when a replacement fraction 230 is determined 160 and/or an item of replacement information 231 is added. After transmission via a transmission system 330, the image recording 210 can be decompressed and adjusted in a central control device 310. To this end, determination 160 of a replacement fraction 230 can be performed again for data decompression on the basis of the replacement information 231. the adjustment 410 may proceed at least in part in the course of data decompression by subtracting and/or evaluating (at 510) the replacement fraction 230, in relation to the reference marker 480. The reference marker 480 is here used (at 520), for example, for adjusting the resolution of the image recording 210.

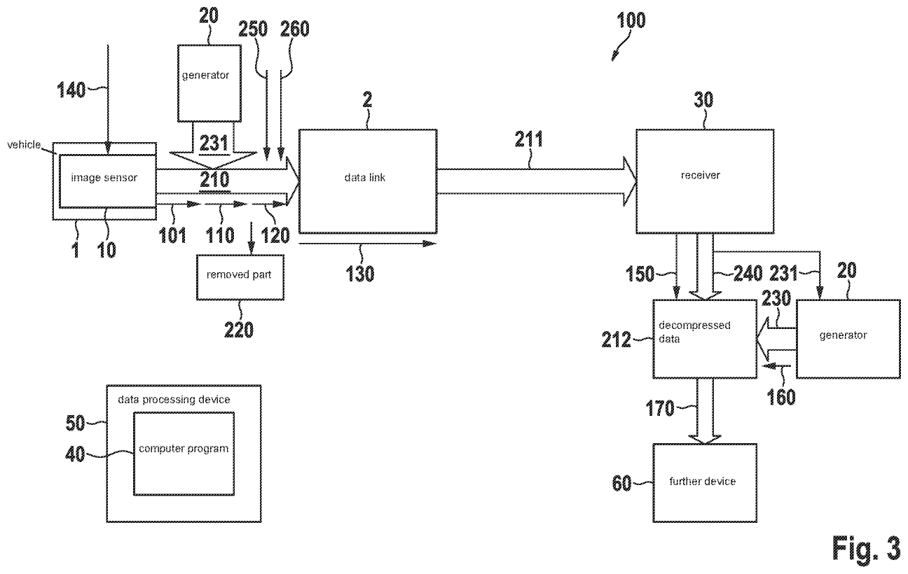

It is possible for the data compression 120 to be lossy data compression 120 of the image recordings 271, 272, as is explained in greater detail in FIG. 3. The image recordings 271, 272 are shown representatively therein as data 210. The lossy data compression 120 may firstly comprise performing preparation 110 of the data 210, in which part of the data 210 is removed and an artificially generated and reproducible replacement fraction 230 is defined as an approximation of the removed part by an item of replacement information 231. In this manner, the data 210 are prepared for subsequently performed lossless data compression 120. During a respective transmission 130 of the data 210, the replacement information 231 may then be transmitted instead of the removed part in order in this manner to achieve a distinct reduction in the volume of data to be transmitted.

The combination of the described data compression 120 with the adjustment 410 performed according to the present invention has the advantage that at least one item of additional information 260 can be introduced into the image recording 271, 272 as early as during the preparation 110. The additional information 260 may be necessary for performing the adjustment 410 and preferably comprises metadata information 440 and/or a reference marker 480.

FIG. 3 shows, with further details, the steps of a method according to the present invention 100 for providing the data 210. An image sensor 10 is shown by way of example which may comprise a chip with defined resolution, frame rate, and noise characteristic. The image sensor 10 is here also representative in FIG. 3 of a plurality of image sensors 11, 12. Digital images which are acquired by such image sensors 10 conventionally contain a high level of entropy which is due in large part to sensor noise. The presence of this noise is an important aspect of what gives the image its natural statistical characteristics. Removing this noise can cause processing algorithms applied to the images, for example in the course of further processing 170, to produce different results than in the case of an image which still contains this noise. The data 210 would therefore be corrupted. The presence of the noise does, however, severely limit the data reduction achievable by lossless compression.

The following description provides greater detail as to how higher compression rates can be achieved by using a replacement fraction 230 while maintaining a realistic noise profile such that corruption of the content can be avoided.

The image sensors 10 may be part of the vehicle 1 and perform a capture 140 in the surroundings 3 of the vehicle 1 or on the vehicle 1 itself. The data 210 may be acquired on the basis of the capture 140 and for example be the sensor data output by the image sensors 10, i.e. the above-described image recordings 271, 272. The capture 140 may comprise a recording of content of relevance to the vehicle function, in particular of objects in the surroundings 3 of the vehicle 1. A vehicle function may furthermore be executed by processing 170 of the data 210.

According to a first method step, the data 210 are acquired 101 in the vehicle 1. The data may here for example be buffered after the capture 140 in order to transmit them at a later point in time when a data link 2 is available. The acquired data 210 may be prepared 110 for transmission 130 by removing part 220 of the data 210 and defining an artificially generated and reproducible replacement fraction 230 by an item of replacement information 231 as an approximation of the removed part 220 in order to prepare the data 210 for, in particular lossless, data compression 120. After removing the part 220, the data 210 may still comprise a remaining fraction 240 which is particularly well suited to lossless data compression 120. The removed part 220 may also be referred to as the first data fraction 220 and the remaining fraction 240 as the second data fraction 240.

The step of preparation 110 may be performed at least in part by a generator 20. This step may furthermore optionally involve adding further information to the data 210, for example an additional item of information 260 and/or a watermark 250. Data compression 120 of the prepared data 210 may then be performed and transmission 130 of the data 211 compressed by way of the data compression 120 may be initiated and/or performed via the data link 2. The removed part 220 is not transmitted here but, instead of the part 220, the replacement information 231 is transmitted together with the remaining fraction 240. The removed part 220 may here be a noise fraction 220 of the data 210 and the replacement fraction 230 artificially generated noise 230, in particular pseudo-noise 230.

The replacement fraction 230 may be defined during preparation 110 by determining the replacement information 231, in particular a seed key for the generator 20 or a random number generator 20. The replacement information 231 may then be used, in particular after transmission 130 and decompression 150 of the data 210, to generate and so reproduce the replacement fraction 230. For the purpose of defining and/or generating 160 the replacement fraction 230, it may also be provided that the replacement fraction 230 be generated in the form of pseudo-noise 230 by using the generator 20. In order to enable bit-identical restoration of the replacement fraction 230, the generator 20 may be embodied with defined initial conditions, in particular as a function of a target noise model, or noise model for short. The initial conditions may be determined and transmitted by the replacement information 231.

FIG. 3 furthermore shows a computer program 40 according to the present invention for executing the method steps and a data processing device 50 according to the present invention.

Removing the part 220 may comprise removing the majority of the noise from the data 210, in particular the image data 210, for example by noise suppression. Corrections, such as for example of sensor-specific noise, noise due to fixed patterns or uneven photosensitivity, may optionally also be made here. This step yields the prepared data 210, which may also be referred to as noise-reduced data 210.

The generated pseudo-noise 230 may optionally be added at a later point in time to the noise-reduced data 210, in particular image data 210, such that the resultant pseudo-noise image precisely imitates the desired noise model. The desired noise model may be suitable for imitating the respective image sensor 10.

The prepared data 210 can be losslessly compressed and transmitted. In addition to the data content, the data 210 may optionally comprise the noise model with the at least one corresponding parameter (thus in particular the replacement information 231 or the seed key), preferably together with metadata and/or further additional information 260. The at least one parameter may be stored, for example using a steganographic key, in the data 210 itself or in further data or a separate file. Lossless compression can be performed for example by a factor of 5 to 10, preferably using a lossless codec defined in the JPEG2000 standard or a user-defined lossless codec. Examples are lossless JPEG or PNG compression or indeed ZIP compression. The at least one parameter of the pseudo-noise may optionally be stored together with the compressed data 210. Decompression 150 may proceed by firstly decompressing the data 210 with the same lossless codec and then generating the pseudo-noise on the basis of the at least one parameter and adding it to the data 210.

Some exemplary variant embodiments of the method steps according to the present invention will now be described in greater detail. The acquired data 210 may here take the form of image data 210 having a plurality of pixels i with the respective values xᵢ. Each pixel i may here include the first data fraction 220, i.e. the noise fraction 220, and the remaining second data fraction 240 with partially redundant information. This means that the two data fractions 220, 240 can overlap. Removing the first data fraction 220 in the course of preparing 110 the data 210 may proceed, for example, by way of noise reduction. Conventional noise suppression techniques can be used for noise reduction. A noise model is conventionally used for this purpose. The prepared data 210 may subsequently comprise only the remaining fraction 240 and thus noise-reduced data 210. The noise model used may, for example, be a Poisson-Gaussian model, for which the estimated standard deviation σᵢ of the pixel i with the value xᵢ is given by σᵢ=\sqrt{a(xᵢ−x₀)+b}. The noise parameters for this model are a. These correlate in particular with the signal amplification in the image sensor 10. The black level of the image sensor 10 may be stated as x₀. Furthermore, b may designate a parameter which is related to the read-out noise of the image sensor 10. While this noise model is preferably suitable for CCD and CMOS raw image data, a simplified model may also be used in which noise is assumed to have a standard deviation σ₀ which is independent of the pixel value. In this case, the number of noise bits per pixel i for the image data 210 may be calculated using integer values as N_{bits}=log₂(σ₀\sqrt{12})=log₂(σ₀)+1.792. This number may for example amount to 6 to 8 bits. Using noise suppression techniques, a noise-reduced value yᵢ can then be determined for the respective values xᵢ of the pixels i. For example, a pseudo-random number generator 20 with a seed S is used for this purpose, S possibly being an integer, in order to generate a pseudo-random number Rᵢ for each pixel i. The noise-reduced pixel values yᵢ of the noise-reduced data 210 may be calculated, by way of example, by:

$${y}_{i} = round ( \frac{{x}_{i}}{\frac{{σ}_{0}}{q}} + {R}_{i} ) .$$

During generation of the noise-reduced data 210 by the noise suppression techniques, the first data fraction 220 is removed. Accordingly, the first data fraction 220 may designate the difference between the originally acquired data 210 and the prepared noise-reduced data 210. The first data fraction 220 may here comprise the majority of the natural noise in the acquired data 210.

Once the part 220 has been removed, the replacement fraction 230 can be defined. The replacement fraction 230 may be pseudo-noise 230 which should approximate as closely as possible to the removed noise. The replacement fraction 230 can be generated on the basis of the replacement information 23, in the present example a seed key. A target noise model may be used for this purpose. In the simplest case, the seed key can be arbitrarily predefined for this target noise model and can be permanently stored for the method according to the present invention. Defining the replacement fraction 230 thus does not require an additional calculation step. Alternatively, the seed key can also be calculated on the basis of the removed part 220, for example by way of an optimization method for noise evaluation in the removed part 220. Such a seed key can then be determined which results in the replacement fraction 230 approximating as closely as possible to the removed part 220. The seed key may also be defined on the basis of the noise characteristic of the image sensor 10 in such a way that the replacement fraction 230 generated therefrom approximates as closely as possible to the removed part 220. The seed key may optionally also be determined empirically or in model-assisted manner.

The remaining fraction 240 can then be compressed, in particular losslessly compressed, and the replacement information 23 transmitted together with the compressed remaining fraction 240 to the receiver 30.

After transmission 130, the remaining fraction 240 may then be decompressed 150 in order to obtain the decompressed data 212. Then, on the basis of the transmitted replacement information 231, the pseudo-noise 230 can be reimprinted on the remaining fraction 240, for example by the following calculation of the pixel values zᵢ:

$${z}_{i} = round ( [ {y}_{i} - {R}_{i} ] \cdot \frac{{σ}_{0}}{q} ) .$$

A noise model and its parameter is used here, the noise model being the functional form of the transformation and the parameters the exact values for σ₀ and q. The pseudo-random number Rᵢ can be calculated by the generator 20 which to this end obtains the transmitted replacement information 231 for random number generation. The data 210 obtained in this manner with the pixel values zᵢ approximate very closely to the original, acquired data 210 and can then be transmitted for further processing 170 to a further device 60.

The preceding explanation of the embodiments describes the present invention solely on an exemplary basis. It goes without saying that individual features of the embodiments may, where technically feasible, be freely combined with one another without departing from the scope of the present invention.

What is claimed is:

1. A method for providing image recordings in a vehicle, the method comprising the following steps performed in an automated manner:
acquiring a first image recording of a first image sensor of the vehicle and at least one further image recording of at least one further image sensor of the vehicle, the first and further image recordings imaging different spatial regions of surroundings of the vehicle, whereby at least one item of information of relevance to a function of the vehicle is provided and the image recordings differing from each other with regard to their resolution and/or their image format;
performing an adjustment of the image recordings with regard to their resolution and/or their image format to a preset, the preset being dependent on at least one instance of processing performed on execution of the vehicle function; and
providing the adjusted image recordings for processing.

2. The method as recited in claim 1, wherein the adjustment is performed during data compression and/or data decompression of the image recordings.

3. The method as recited in claim 1, wherein the adjustment includes standardization of the resolutions of the first and further image recordings to a target resolution and/or of the image formats of the first and further image recordings to a target image format such that the first and further image recordings are available in the target resolution and/or in the target image format during processing.

4. The method as recited in claim 1, wherein the processing is configured to receive the first and further image recordings solely in a uniform resolution calculated by the adjustment and/or a uniform image format calculated by the adjustment including a target resolution and/or a target image format.

5. The method as recited in claim 1, wherein at least one additional item of information is integrated into the first and further image recordings, the additional item of information being specific to the resolution and/or the image format and the adjustment being performed based on the additional item of information.

6. The method as recited in claim 1, wherein the acquisition of the first and further image recordings is performed decentrally in the vehicle at the first and further image sensors, respectively, the first and further image recordings then being transmitted to a processing unit, and the adjustment then being performed by the processing unit, after the transmission.

7. The method as recited in claim 1, wherein, after the acquisition and before the adjustment, data compression and transmission of the image recordings are performed, transmission from the first and further image sensors being performed from different positions on the vehicle and with different transmission paths.

8. The method as recited in claim 1, wherein the first and further image recordings are stitched together as a function of imaged surrounding regions, whereby a stitched-together image recording is obtained, the stitched-together image recording being adjusted and/or provided for the processing.

9. The method as recited in claim 1, wherein the adjustment is performed by a trained algorithm which was obtained by training with image recordings of a different resolution and/or a different data format.

10. The method as recited in claim 1, wherein lossy data compression of the first and further image recordings is performed, the lossy data compression including the following steps:
performing preparation of each respective image recording of the first and further image recordings, in which part of the image recording is removed and an artificially generated and reproducible replacement fraction is defined by an item of replacement information as an approximation of the removed part in order to prepare the image recording for lossless data compression,
performing the lossless data compression on the respectively prepared image recordings;
wherein the replacement information is transmitted instead of the removed part during a respective transmission of the first and further image recordings, and performance of the preparation including the following step:
introducing at least one item of additional information into the respective image recording, which information includes an item of metadata information and/or a reference marker, based on which the adjustment is performed.

11. A non-transitory computer-readable medium on which is stored a computer program including commands for providing image recordings in a vehicle, the commands, when executed by a computer, causing the computer to perform the following steps in automated manner:
acquiring a first image recording of a first image sensor of the vehicle and at least one further image recording of at least one further image sensor of the vehicle, the first and further image recordings imaging different spatial regions of surroundings of the vehicle, whereby at least one item of information of relevance to a function of the vehicle is provided and the image recordings differing from each other with regard to their resolution and/or their image format;
performing an adjustment of the image recordings with regard to their resolution and/or their image format to a preset, the preset being dependent on at least one instance of processing performed on execution of the vehicle function; and
providing the adjusted image recordings for processing.

12. A device configured to provide image recordings in a vehicle, the device configured to:
acquire a first image recording of a first image sensor of the vehicle and at least one further image recording of at least one further image sensor of the vehicle, the first and further image recordings imaging different spatial regions of surroundings of the vehicle, whereby at least one item of information of relevance to a function of the vehicle is provided and the image recordings differing from each other with regard to their resolution and/or their image format;
perform an adjustment of the image recordings with regard to their resolution and/or their image format to a preset, the preset being dependent on at least one instance of processing performed on execution of the vehicle function; and
provide the adjusted image recordings for processing.
